(19) United States
(12) Patent Application Publication
(10) Pub. No.: US 2013/0056600 A1
(43) Pub. Date: Mar. 7, 2013

(54) Blocking support hanger

(71) Applicant: Snell James Richard, Virginia Beach, VA (US)

(72) Inventor: Snell James Richard, Virginia Beach, VA (US)

(21) Appl. No.: 13/137,664

(22) Filed: Sep. 1, 2011

(51) Int. Cl. F16M 13/02; F16B 2/02

(52) U.S. Cl. 248/231.71

(57) ABSTRACT

A Blocking Support Hanger is made from galvanized sheet metal bent into a C shape with an integral U shaped flange at the end of the top C flange that fits over the bottom flange of a bulb tee, steel bar joist, I-beam and other flanged type structural support framing. Various gages and widths of galvanized sheet metal will be used to fabricate the blocking support hangers in order to support differing weight and span length of the structural support framing as needed to support the materials attached to the blocking supported by the blocking support hanger. The blocking support hanger assembly provides a simple installation to the bottom of an existing support frame, inexpensive, capable of a wide range of nonstructural support product installations, allows quick, lasting easy installation.

### BACKGROUND OF THE INVENTION

This invention relates to attachment of a non-structural support systems, and more particularly relates to a blocking support hanger for attaching blocking or backing to support non-structural items or systems in place to non-nailable materials supported by a support structure.

Light weight metal and wood soffit, ceiling and trims systems must have a support system or attachment point from the bottom of a steel bulb tee deck support frame of a building structure. The bulb-tee deck support frame are spaced 2′-6″ or more apart and are often exposed as is the deck material to the interior and exterior of the structure. The deck material is usually a cements or gypsum material between the bulb tees that will not support common fasteners. Light weight metal panel soffit systems, metal ceilings, sheetrock, acoustical tile, metal tile, metal trim, wood trim, conduit, fans, and other items require both continuous and single member blocking attached to support the items and systems from the support structure.

The light weight soffit, ceiling and trim members must be supported from these steel bulb tees by a means that is safe, strong, easily and quickly attached to the steel bulb tees with deck in place or with no deck in place to the continuous support blocking, and attaches the system securely in place.

### SUMMARY OF THE INVENTION

The object of this invention to provide such means for attaching blocking to support light weight soffit, ceilings, trims, conduit, fans and other members both continuous and single from the support structure. Another objective is to provide such means which is simple and relatively inexpensive.

The objects of this invention are accomplished by providing a blocking support hanger which mates over the bottom of the steel bulb-tee flange on both sides and is locked thereto by a fastener, and which fastens onto the blocking member and is locked thereto by a fastener to each side of the support hanger that is prevented from upward movement by the wood or metal blocking inserted into both sides of the blocking support hanger under and over the steel bulb tee flange.

### BRIEF DESCRIPTION OF THE DRAWINGS

Other objects and advantages of the invention will further become apparent hereinafter and in the drawings, in which:

FIG. 1 is a fragmentary perspective view of the top of a steel bulb tee structure showing bulb tees supporting tectum tile deck over the bottom flange on both sides of the bulb tees and blocking support hangers attaching the blocking to the blocking support hanger member;

FIG. 2 is an end view of the blocking support hanger shown attached to the steel bulb tee and locked together with a center fastener through both blocking support hangers and with fasteners installed in both of the bottom flanges of the blocking support hanger to the wood or metal blocking. A light weight metal soffit is shown attached to the wood or metal blocking supported by the blocking support hanger attached to the steel bulb tee.

FIG. 3 is a side elevation of the blocking support hanger constructed in accordance with this invention.

### DESCRIPTION OF THE PREFERRED EMBODIMENT

Although specific terms are used in the following description for clarity, these terms are used to refer only to the structure shown in the drawings and are not intended to define or limit the scope of the invention.

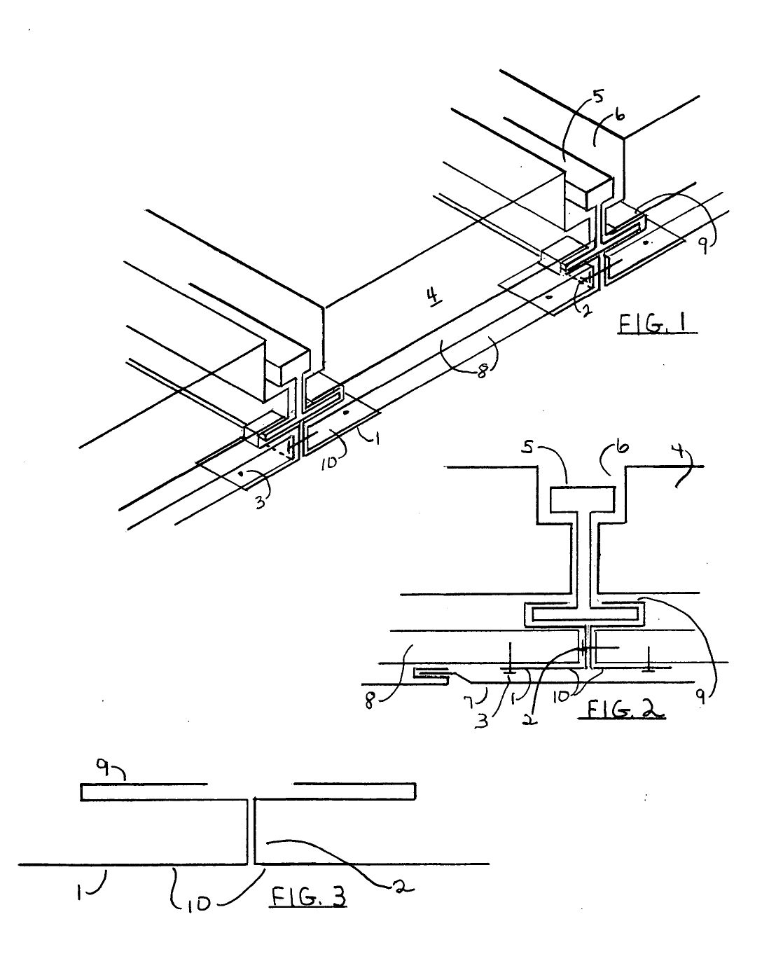

Turning now to the specific embodiment of the invention selected for illustration in the drawings, there is shown in FIG. 1 a partial view in perspective of a steel bulb tee support system including a plurality of interlocking blocking or members 8. Each of the continuous main blocking members 8 have fasteners 3 installed vertical into members 8, outwardly projecting horizontal flanges 1 at the bottom of the vertical C 2, and a horizontal flange 9 is shown at the top of vertical C 2.

The bottom horizontal flanges 5 of steel bulb tee members support the 10 blocking support hangers top flange 9, and the blocking members are supported from a series of blocking support hangers by a plurality of steel bulb tees 5.

The top flange of the 10 blocking support hanger can be installed before the deck is installed or after the 4 tectum deck that has been sealed with 6 tectum cement is installed by driving the 9 top flange over the 5 steel bulb tee flange.

To insure that the blocking remains in place and does not ride or move upwardly, the blocking is installed between the bottom flange 1, and the top inside flange of C 2 filling the space to the bottom bulb tee flange 5 and the top flange 9 is inserted over the bottom flange of the steel bulb tee flange 5 that supports the blocking support hanger.

There is shown in FIG. 2 the steel bulb tee is shown with the top flange 9 over the bottom flange 5 with continuous blocking fastened the center at each steel bulb tee member and under from the bottom flange 1 into the wood or metal blocking 8 with a light weight metal soffit 7 attached to the continuous blocking 8.

There is shown in FIG. 3 is the side elevation of 10 blocking support hanger constructed in accordance with this invention as bottom flange 1, C 2 vertical leg to top lower horizontal leg 9 that will turn up and over the bottom steel bulb tee flange.

It is to be understood that the form of the invention herewith shown and described is to be taken as a presently preferred embodiment. Various changes may be made in the shape, size and arrangement of parts. For example, equivalent elements may be substituted for those illustrated and described herein, parts may be reversed and certain features of the invention may be utilized independently of the use of other features, all without departing from the spirit or scope of the invention as defined in the subjoined claims.

1. In a soffit, trim, ceiling and various other items a support system and attachment point is required, a blocking support hanger comprising first means for attaching to a steel bulb tee structure, second means for attaching to a soffit, trim and ceiling blocking member, said second means including attachment bulb blocking support hanger member, a first locking means is fastening through the center of the vertical leg at both sides of the steel bulb tee vertical leg to the mounted blocking support hangers for locking them in place, and second locking means is the bottom flange fastened into the blocking for locking the first locking means in place, said first locking means comprising a blocking into the vertical leg from the bottom flange to the top interior horizontal flange and installing the top flange over the steel bulb tee bottom flange that prevents upward movement of first locking means.

2. The blocking support hanger can be installed before or after the deck members are installed.
